(19) United States
(12) Patent Application Publication
(10) Pub. No.: US 2018/0191922 A1
(43) Pub. Date: Jul. 5, 2018

(54) IMAGE FORMING APPARATUS, PRINTING METHOD, AND NON-TRANSITORY STORING MEDIUM

(71) Applicants: KABUSHIKI KAISHA TOSHIBA, Tokyo (JP); TOSHIBA TEC KABUSHIKI KAISHA, Tokyo (JP)

(72) Inventor: Jun SASANO, Kokubunji Tokyo (JP)

(21) Appl. No.: 15/393,410

(22) Filed: Dec. 29, 2016

(51) Int. Cl. H04N 1/32; H04N 1/00; B41M 7/00

(52) U.S. Cl. CPC H04N 1/32133; H04N 1/00206; H04N 2201/3215; H04N 2201/0094; H04N 2201/3214; B41M 7/0009

(57) ABSTRACT

An image forming apparatus includes an interface through which printing data to be printed onto a sheet is acquired, and a printer unit configured to print the printing data, and to print information different from the printing data on the sheet using a decolorable recording agent.

### FIELD

Embodiments described herein relate generally to an image forming apparatus, a printing method, and a non-transitory storage medium.

### BACKGROUND

In the related art, in an image forming apparatus, when printing data received from a facsimile machine, information such as the date and time of when printing data was received, or management information such as the time and date of printing, etc., is generally printed with the printing data.

However, in a case where a user wants to use the sheet on which the printing data received from the facsimile machine has been printed as an original document, the additional information may not be necessary and may be unwanted. Such a problem is not limited to the additional information which is added at the time of receiving the information from the facsimile machine, and is common to all sheets on which information different from the printing data is printed.

### DESCRIPTION OF THE DRAWINGS

FIG. 1 is an exterior view illustrating an example of the entire configuration of an image forming apparatus of an embodiment.

FIG. 2 is a block diagram illustrating a functional configuration of the image forming apparatus.

FIG. 3 is a view illustrating a result of printing the printing data received from a facsimile machine.

FIG. 4 is a view illustrating a result of decoloring on a sheet.

FIG. 5 is a flowchart of operations of the image forming apparatus.

### DETAILED DESCRIPTION

An image forming apparatus of an embodiment includes an interface through which printing data to be printed onto a sheet is acquired, and a printer unit configured to print the printing data, and to print information different from the printing data on the sheet using a decolorable recording agent.

Hereinafter, the image forming apparatus, a printing method, and a non-transitory storing medium of the embodiment will be described with reference to drawings.

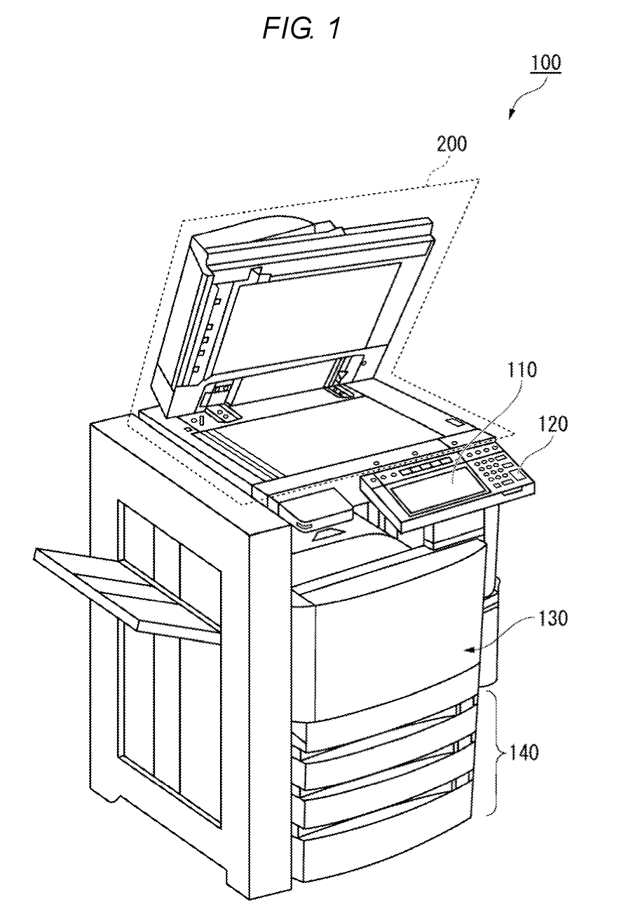

FIG. 1 is an exterior view illustrating an example of an image forming apparatus 100 of the embodiment.

The image forming apparatus 100 of the embodiment is a multi-function machine (multi-function peripheral; MFP) which is capable of forming toner images on sheets. The image may be, for example, that on original documents, paper on which characters, images, or the like are formed, or the like. The image may be formed on any article, as long as being capable of read by the image forming apparatus 100. The image may also be in the form of a digital file, or a file received from a facsimile machine whereby an original image on a sheet(s) was scanned and converted into a digital file or digital image, and the digital file was transmitted to the MFP. The image forming apparatus 100 generates digital data by reading an image on the sheet, and generates an image file.

The image forming apparatus 100 includes a display 110, a control panel 120, a printer unit 130, a sheet accommodating unit 140, and an image reading unit 200. The printer unit 130 of the image forming apparatus 100 may be a device for fixing toner images, or may be an ink jet type device. In the embodiment, the printer unit 130 will be described as an example in which the unit is a device for fixing toner images onto the sheet.

The display 110 is an image display device such as a liquid crystal display or an organic electro luminescence (EL) display. The display 110 displays various information relating to the image forming apparatus 100. In addition, the display 110 outputs a signal in accordance with an input operation of a user inputting information to a controller of the image forming apparatus 100.

The control panel 120 includes a plurality of selectable buttons. The control panel 120 receives an operation input by the user. The control panel 120 outputs a signal in accordance with an input operation of the user to the controller of the image forming apparatus 100. Also, the display 110 and the control panel 120 may be an integrally configured touch panel.

The printer unit 130 performs an image forming process. In the image forming process, the printer unit 130 forms images on the sheets based on image information generated by the image reading unit 200 or image information received by the image forming apparatus 100 through a communication line connected thereto, or through a wireless connection. In addition, the printer unit 130 may also form images on the sheets based on printing data acquired from other devices. The printer unit 130 may perform printing using decolorable toner and non-decolorable toner. The decolorable toner is toner having a decolorable recording agent. The decolorable toner can be decolored by being heated to a decoloring temperature higher than a temperature used when the image fixing process is performed with that same toner. The non-decolorable toner is toner having a recording agent which cannot be decolored. Here, “decoloring” means causing images, which are formed of colors (including achromatic colors such as white and black as well as chromatic colors) different from colors of a base of the sheet, to be invisible to the human eye.

The sheet accommodating unit 140 accommodates sheets which are to be subjected to an image forming process by the printer unit 130.

The image reading unit 200 reads image information of a reading target as the brightness and darkness of the image thereon when illuminated. The image reading unit 200 records the read image information. The recorded image information may be transmitted to other information processing devices through a network. The recorded image information may be formed as images on one or more sheets using the printer unit 130.

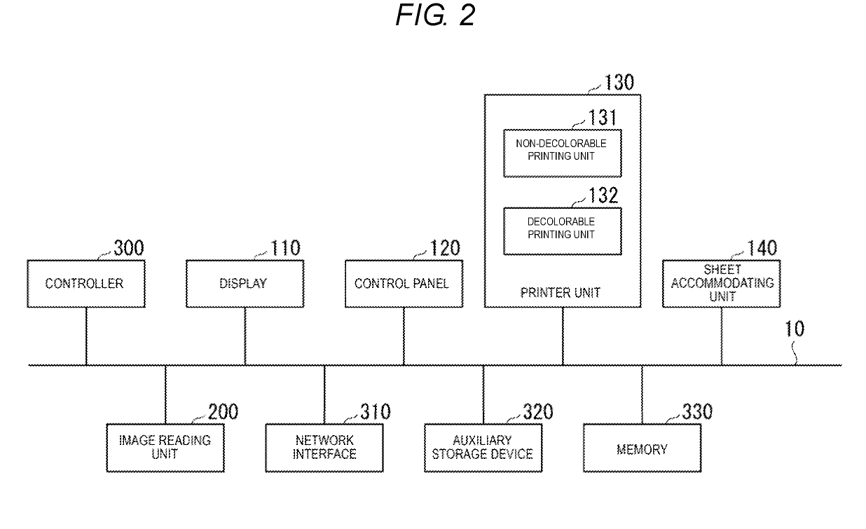

FIG. 2 is a block diagram illustrating a functional configuration of the image forming apparatus 100.

A further explanation of the display 110, the control panel 120, the sheet accommodating unit 140, and the image reading unit 200 are omitted because configurations thereof are the same as those of units described above. Hereinafter, a printer unit 130, a controller 300, a network interface 310, an auxiliary storage device 320, and a memory 330 are explained. Also, each functional unit is connected each other so as to be capable of being data-communicated through a system bus 10.

The printer unit 130 includes a non-decolorable printing unit 131 and a decolorable printing unit 132. The non-decolorable printing unit 131 performs printing using the non-decolorable toner according to a control of the controller 300. The decolorable printing unit 132 performs printing using the decolorable toner as instructed by the controller 300. The printer unit 130 prints the additional information, which is information different from the printing data at the time of printing of the printing data, on the sheets using the decolorable toner.

The controller 300 controls operations of each functional unit of the image forming apparatus 100. The controller 300 performs various processes by executing programs. For example, the controller 300 control as follows in a case where information is received from the facsimile machine through the network interface 310. The controller 300 performs printing using the non-decolorable printing unit 131 using non-decolorable toner in a case where the information received from the facsimile machine is printed on the sheets. In addition, the controller 300 performs printing using the decolorable printing unit 132 using the decolorable toner in a case where the additional information is printed on the sheets. The additional information is not original printing data, and is information added by the image forming apparatus 100, and for example, it is printed on the margin (for example, header or footer) of the sheet. For example, the additional information is information such as the number of received page(s), date and time, or managing serial number. Also, the additional information maybe printed on regions of the sheet other than the header or footer of the sheet. For example, the additional information may be printed on a different, pre-determined, region on the sheet.

The network interface 310 transmits/receives data to/from other devices. The network interface 310 is operated as an input interface, and receives data transmitted from other devices. For example, the network interface 310 receives the printing data from the facsimile machine. In addition, the network interface 310 operates as an output interface, and transmits data to other devices.

The auxiliary storage device 320 is, for example, a hard disk or a solid state drive (SSD), and stores various data items. The various data items are, for example, digital data, a job, a job log, and the like. The digital data is generated by the image reading unit 200.

The memory 330 is, for example, a random access memory (RAM). The memory 330 temporarily stores data, which is used by each functional unit provided in the image forming apparatus 100. For example, the memory 330 temporarily stores the printing data. Also, the memory 330 may store digital data generated by the image reading unit 200. The memory 330 may temporarily store a print job and a job log.

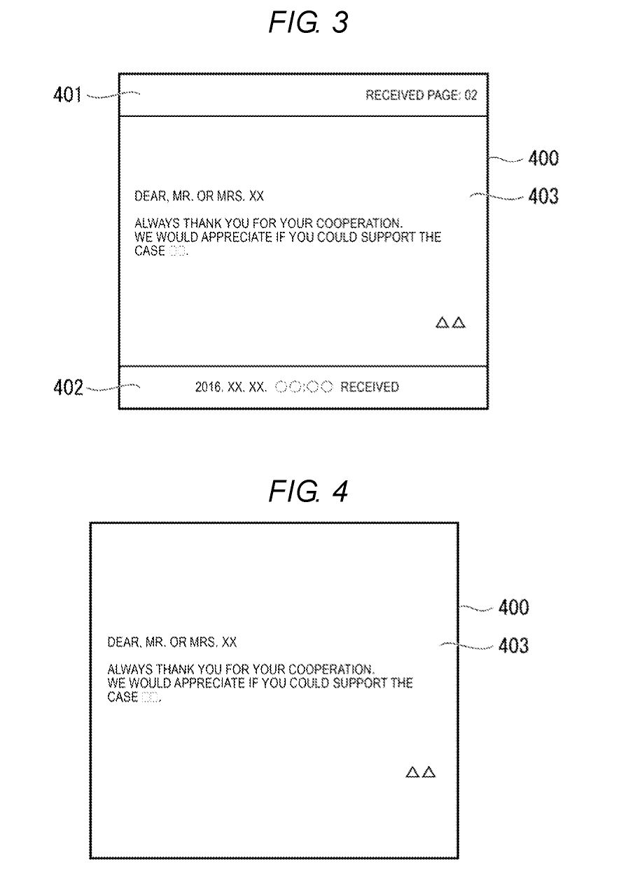

FIG. 3 depicts a result of printing the printing data which is received from a facsimile machine. In an example illustrated in FIG. 3, the additional information is printed on a header 401 and a footer 402 of a sheet 400, and the printing data is printed on a body 403. In the embodiment, the controller 300 causes the additional information being printed on the header 401 and the footer 402 of the sheet 400 to be printed using the decolorable toner, and causes information to be printed on the body 403 of the sheet 400 to be printed using the non-decolorable toner. Accordingly, the additional information printed on the header 401 and the footer 402 of the sheet 400 can be decolored. A result of decoloring the header 401 and the footer 402 of the sheet 400 is illustrated in FIG. 4.

FIG. 4 is a view illustrating the result of decoloring the sheet 400. As illustrated in FIG. 4, when the decoloring process is performed on the sheet 400, the additional information which is printed on the header and the footer is decolored. Accordingly, only the printed image of the printing data printed with a non-decolorable, i.e., permanent, printing agent is visible on the sheet 400.

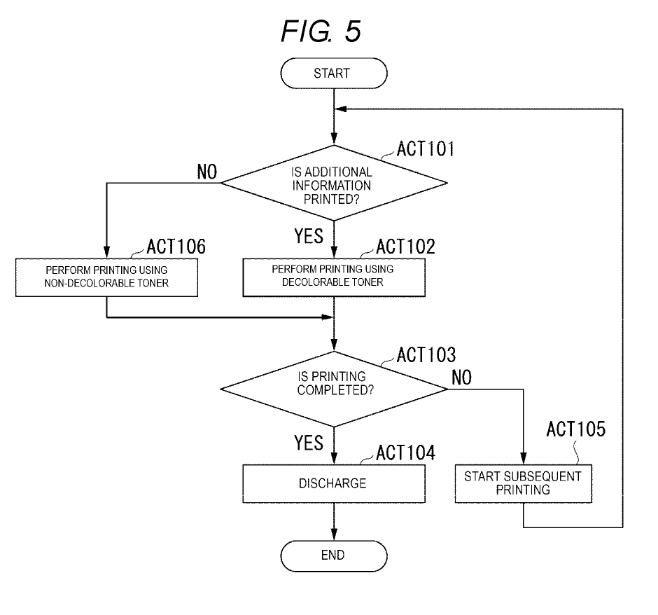

FIG. 5 is a flow chart of the operations of the image forming apparatus 100. Here, operations of FIG. 5 are performed in a case where the printing data is received from the facsimile machine.

The controller 300 acquires the printing data through the network interface 310. The controller 300 controls the printer unit 130 to print the acquired printing data on the sheet. Here, it is determined whether or not information being printed at this time (for example, printing of a first line of the sheet) is the additional information (ACT 101). If the information being printed is the additional information (YES in ACT 101), the printer unit 130 performs printing on the sheet using decolorable toner (ACT 102). Specifically, the controller 300 controls the decolorable printing unit 132 to print the additional information on the header or the footer of the sheet. Subsequently, the controller 300 determines whether or not the printing is completed (ACT 103). Here, completion of printing means that printing of the printing data and printing of the additional information are performed on one sheet. If the printing is completed (YES in ACT 103), the printer unit 130 discharges the sheet on which printing is completed (ACT 104).

On the other hand, if the printing is not completed (NO in ACT 103), the image forming apparatus 100 starts subsequent printing process (ACT 105). For example, the image forming apparatus 100 performs printing of the printing data on the body of the sheet after the additional information is printed on the header of the sheet.

In addition, at ACT 101, if the printing is not for printing the additional information (NO in ACT 101), the printer unit 130 performs printing on the sheet using the non-decolorable toner (ACT 106). Specifically, the controller 300 controls the non-decolorable printing unit 131 to print the printing data on the sheet. Next, process of ACT 103 is performed.

According to the image forming apparatus 100 configured as described above, the additional information added at the time of receiving the printing data is printed using the decolorable toner. Accordingly, in a case where the additional information is not necessary (for example, sheet is used as an original document), the additional information can be decolored. Therefore, the sheet in which the additional information is printed can be utilized as an original document.

In addition, the printed additional information is visible on a sheet which is not decolored. Therefore, the additional information is easily used for managing printed sheets, or the like.

Hereinafter, a modification example of the image forming apparatus 100 will be described.

In the above embodiments, an example in a case where the printing data is received from the facsimile machine is explained, the controller 300 may also perform the same process on the printing data acquired from other devices. For example, the controller 300 causes the image forming apparatus to perform printing of the additional information using decolorable toner even when the printing data is printed based on a printing instruction from other information processing device. The information processing device is, for example, a personal computer, a lap top computer, a tablet terminal, a mobile phone, a smartphone, or the like. For example, the controller 300 performs printing of the additional information using decolorable toner, even when the additional information is printed in a case where printing data stored in a universal serial bus (USB) memory is printed. As described above, the controller 300 performs the operations described above on every sheets on which any information different from the printing data is printed as well as the additional information added at the time of receiving information from the facsimile machine.

In the embodiment, as the decolorable toner, a configuration in which toner which is decolorable by heat is used is exemplified, but the decolorable toner is not be necessarily limited to the above example. For example, as the decolorable toner, toner which can be decolored by other than heat (for example, light of a specific wavelength, pressure, or the like) may be used.

According to at least one of the embodiments described above, the image forming apparatus 100 includes the interface (network interface 310), and the printer unit 130. The interface acquires the printing data which is subjected to being printed on a sheet 400. The printer unit prints additional information which is newly added at the time of printing of the printing data on the sheet using the decolorable recording agent (decolorable toner). The image forming apparatus 100 is configured as described above, and thus the sheet on which the additional information is printed can be utilized as an original document.

A partial function of the image forming apparatus 100 in the embodiment described above may be realized using a computer. In this case, programs for realizing the function are stored in a storing medium readable by a computer. Also, the functions may be realized by reading and executing the program described above, which is stored in a storing medium, using a computer system. Moreover, the “computer system” described here includes an operating system or a hardware of a peripheral equipment. In addition, the “storing medium readable by a computer” means a portable medium, a storage device, and the like. The portable medium is a flexible disk, a magneto-optical disk, ROM, CD-ROM, and the like. In addition, the storage device is a hard disk built in the computer system, and the like. Further, the “storing medium readable by a computer” means a medium holding the program dynamically for a short time, such as a communication line in a case where the program is transmitted through a communication line. The communication line is a network such as the Internet, a telephone line, or the like. In addition, the “storing medium readable by a computer” may be a volatile memory inside a computer system which is a server or a client. The volatile memory holds a program for a certain period of time. Also, the program described above may realize a part of functions described above. The program may further realize the functions described above by combination of programs previously stored in the computer system.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein maybe made without departing from the spirit of the inventions. The accompanying claims and their equivalents are intended to cover such forms or modifications as would fall within the scope and spirit of the invention.

1. An image forming apparatus comprising:
an interface through which printing data to be printed onto a sheet is acquired; and
a printer unit configured to print the printing data, and to print information different from the printing data on the sheet using a decolorable recording agent.

2. The apparatus according to claim 1,
wherein the information different from the printing data is provided by the image forming apparatus.

3. The apparatus according to claim 1,
wherein the printer unit prints the printing data on the sheet using a non-decolorable recording agent.

4. The apparatus according to claim 1,
wherein the printer unit prints the information different from the printing data on a region of the sheet different from a region of the sheet on which the printing data is printed.

5. The apparatus according to claim 4,
wherein the printer unit prints the information different from the printing data on a margin of the sheet.

6. The apparatus according to claim 1, further comprising:
a controller configured to determine a first printing region on which to print the printing data and a second printing region on which to print the information different from the printing data,
wherein the controller controls the printer unit to print in the first and second printing regions, and switches between different recording agents used for printing by the printer unit in the first and second printing regions.

7. The apparatus according to claim 1,
wherein the information different from the printing data includes at least a date when the printing data is received by the image forming apparatus.

8. The apparatus according to claim 1,
wherein the printing data is received through the interface from one of an information processing device and an external memory.

9. The apparatus according to claim 1,
wherein the printing data is received through the interface from a facsimile machine.

10. The apparatus according to claim 1,
wherein the printer unit prints the information different from the printing data on at least one of a header region and a footer region of the sheet.

11. A printing method comprising:
acquiring printing data to be printed on a sheet through an interface; and
printing additional information, which is different from the printing data, on a sheet in a printer unit using a decolorable recording agent.

12. The method according to claim 11,
wherein the additional information is provided by the printer unit.

13. The method according to claim 11,
wherein a non-decolorable recording agent is used to print the printing data on the sheet.

14. The method according to claim 11,
wherein the additional information is printed on a region of the sheet different from a region of the sheet where the printing data is printed.

15. The method according to claim 14,
wherein the additional information is printed on a margin of the sheet.

16. The method according to claim 11, further comprising:
determining a first printing region for the printing data and a second printing region for the additional information; and
controlling the printer unit to switch between different recording agents used for printing by the printer unit during printing in the first and second printing regions.

17. The method according to claim 11,
wherein the additional information includes at least a date when the printing data is received by the printer unit.

18. The method according to claim 11,
wherein the printing data is received through the interface from one of an information processing device and an external memory.

19. The method according to claim 18,
wherein the printing data is received through the interface from a facsimile machine.

20. An image printing apparatus for printing an image from printing data acquired through an interface and decolorable data, the image printing apparatus including a non-transitory computer readable storage medium that stores a computer program for causing a computer to execute the steps of:
printing the decolorable data, which is different from the printing data, on a sheet using a decolorable recording agent; and
printing the printing data on the sheet using a non-decolorable recording agent.
